(19) United States
(12) Patent Application Publication
(10) Pub. No.: US 2004/0101746 A1
(43) Pub. Date: May 27, 2004

(54) Feedthrough assembly and method

(75) Inventors: Naoki Ota, Stevenson Ranch, CA (US); David DeMuth, Santa Clarita, CA (US); Hiroshi Nakahara, Santa Clarita, CA (US)

Correspondence Address: MARY ELIZABETH BUSH, QUALLION LLC, P.O. BOX 923127, SYLMAR, CA, 91392-3127, US

(73) Assignee: Quallion LLC, Sylmar, CA (US)

(21) Appl. No.: 10/307,560

(22) Filed: Nov. 27, 2002

(51) Int. Cl. H01M 2/26; H01M 10/40; H01M 10/04

(52) U.S. Cl. 429/161; 429/181; 429/332; 429/211; 29/623.1; 29/623.5

(57) ABSTRACT

A feedthrough assembly and method for a battery includes a corrosion-prone pin coupled to a corrosion-resistant current collector and protected from the battery electrolyte by a protective covering. The current collector is connected to the battery electrode without danger of exposing the pin to the electrolyte.

### TECHNICAL FIELD

The present invention relates to battery components, and more particularly, a battery feedthrough assembly and method for making it.

### BACKGROUND

In many applications, particularly those in medical and aerospace fields, minimizing weight is a major goal in battery design. As battery technology continues to make great strides, battery sizes have greatly decreased. Because of size and weight constraints, the number of available materials used to provide various battery functions is decreasing.

Electronic device seals that bond glass and other ceramics to metal are generally known in the art. Molecular bonding is accomplished by oxidizing the surface of the metal component to facilitate bonding to the glass component. Heating the components causes the glass to soften and flow into the oxidized area of the metal component thereby creating a hermetic seal when the components are cooled. It is desirable for the glass and metal to have similar coefficient of thermal expansions (CTE) to avoid stress breaks during the heating and cooling processes. Preferably, a compression seal is created, for example, where an outer body (typically a case) has a CTE that is greater than an insulating component (typically glass), and the insulating component has a CTE that is greater for that of a metal component (typically a pin). Once heated to 950° C. or greater, the differing CTE facilitates the glass flowing into the case to form a seal, and likewise, the glass to compress the pin to form yet another seal. Nonglass ceramics may be sealed to the metal using a braze, for example, as described in pending application U.S. Ser. No. 09/774,450 filed Jan. 30, 2001, which is assigned to the assignee of the present invention and is hereby incorporated herein by reference in its entirety.

To manufacture a battery, typically, an electrode assembly is placed in a case having a cover with an opening that exposes the battery terminal. To keep weight at a minimum, it is desirable to use strong, yet lightweight materials for the battery case and cover. These materials ideally include titanium and titanium alloys. However, titanium presents problems in most applications in that its CTE varies greatly from materials traditionally used for the feedthrough pin, resulting in seal failures.

The battery case is hermetically sealed to prevent corrosion and to avoid leakage of the internal electrolyte, which is typically very corrosive. Because of corrosion issues, only a limited number of materials can be used in contact with the electrolyte. For the positive feedthrough of a lithium ion battery, these materials include aluminum, platinum, gold, niobium, tantalum, molybdenum, and stainless steel. Because the CTE of the desirable battery cover material, e.g. titanium, is generally markedly different from the CTE of desirable pin material, e.g. stainless steels that can withstand electrolyte exposure, there exists a tendency for these materials to expand and contract at differing rates. The CTE of the insulating member, which may be a glass or nonglass ceramic, may be different from one or both components as well. These differences in CTE make it difficult to form a good seal between the insulating body and the case or terminal pin during manufacturing, or may cause the seal to break during use.

To prevent these problems, the prior art has generally called for the requirement of materials that have compatible CTEs. As mentioned previously, a compression seal can be formed when the CTE for the pin material is less than that of the battery cover material. A quick look at stainless steel CTE reveals that these CTE are larger than that for titanium and the Ti-6Al-4V alloy, essentially eliminating this combination of materials for forming a seal.

TABLE 1
shows the CTE of various materials.

CTE
[10⁻⁶/° C.]

Conductors

| | |
|---|---|
| Aluminum | |
| 1000 series (1004) | 23.5 |
| Gold | |
| Au 100 | 14 |
| Nickel | |
| 42 Alloy | 4.7 |
| Kovar (Co17, Ni29) | 6 |
| Platinum | |
| Pt 100 | 9 |
| PtIr | 9.2 |
| Stainless Steel | |
| 304 | 17.2 |
| 304L | 17.2 |
| 305 | 17.2 |
| 316 | 15.9 |
| 316L | 15.9 |
| 410 | 9.9 |
| 420 | 10.3 |
| 446 | 10.4 |
| Titanium | |
| Titanium CP | 8.4 |
| Ti 6AL-4V | 8.8 |
| Insulators | |

Insulators

| | |
|---|---|
| Nonglass Ceramics | |
| Al₂O₃ | 7.6 |
| Glass | |
| CaBAl 12 | 6.7 |

### SUMMARY

The present invention is an efficient and economical feedthrough assembly and method used in a battery. The battery is preferably made of strong, lightweight material such as titanium. A pin, substantially housed by the battery cover, is insulated from the cover by an insulative member. The assembly is at least partially enveloped by a protective covering to protect it from contact with corrosive electrolyte. In some preferred embodiments of the invention, the pin is sealed to the insulative member after the protective coating is applied. In other embodiments of the invention, the protective coating may be applied after sealing the pin to the insulative member. The present invention allows for use of numerous embodiments and materials as may be desirable in varying applications. While the invention herein is illustrated using a positive terminal, the same technology may be applied to make a negative terminal.

Several embodiments of the present invention are disclosed that provide a new and improved feedthrough assembly and method that may be easily and efficiently manufactured at low cost with regard to both materials and labor. These feedthrough assemblies are of durable and reliable construction and are useful in a myriad of applications and situations.

### BRIEF DESCRIPTION OF THE DRAWINGS

The accompanying drawings, which are incorporated in and constitute a part of the specification, illustrate presently preferred embodiments of the present invention, and together with the preceding general description and the following Detailed Description, explain the principles of the present invention.

FIG. 1 is a diagram of a preferred embodiment of the present invention illustrating its principal components.

FIG. 2 is a diagram illustrating an electrode connected to the feedthrough of FIG. 1.

FIG. 3 is a diagram of an alternative preferred embodiment of the present invention illustrating its principal components.

FIG. 4 is a diagram of another alternative preferred embodiment of the present invention illustrating its principal components.

FIG. 5 is a diagram of yet another preferred embodiment of the present invention.

FIG. 6 is a diagram of an alternative preferred embodiment of the present invention illustrating a pin with protruding base.

FIG. 7 is a diagram of an alternative embodiment of the present invention wherein the current collector forms a core of the terminal.

FIG. 8 is a diagram of an alternative embodiment of the present invention wherein the coating is applied to the pin after scaling the pin to the insulative member.

FIG. 9 is a diagram of an alternative embodiment of the present invention wherein the current collector extends to cover a portion of the pin.

FIG. 10 is a diagram of an alternative embodiment of the present invention wherein the current collector extends to cover a portion of the pin.

### DETAILED DESCRIPTION

Embodiments consistent with the present invention address the need for an efficient and reliable feedthrough assembly and method. The device and method described herein may be implemented in a variety of manners. Accordingly, the description of a particular embodiment herein is intended only for the purposes of example, and not as a limitation. Features described with respect to an embodiment described herein are not limited to that embodiment and may be applied to other embodiments described herein. While the invention herein has been illustrated using a positive terminal, which derives appreciable benefit from the invention, the same technology may be applied to make a negative terminal.

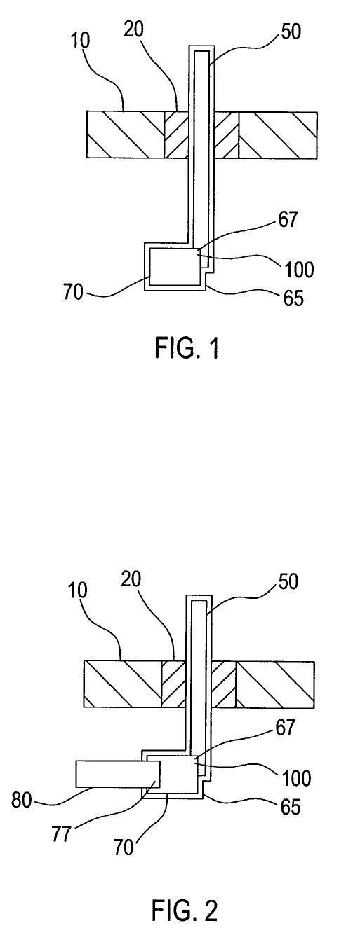

FIG. 1 is a diagram of a preferred embodiment of the feedthrough of the present invention illustrating its principal components. The battery case 10 in the present invention can be made of strong, durable, and lightweight material such as titanium. A feedthrough pin 50 is insulated from case 10 by an insulative member 20, typically made of glass such as CaBAl 12 or Fusite 435, and extends through the battery case 10 for connection to an electrode within the battery case via current collector 70. Because of the design flexibility achieved by the present invention, the feedthrough may be built directly into the side or cover of a battery case without the need for a ferrule; alternatively, the feedthrough may include a separate metal ferrule that surrounds the insulative member and that is welded or otherwise sealed to a battery case wall or cover. Therefore, as used herein, the term “case” and the reference numeral “10” may refer to either a wall or cover of the battery case or to a ferrule welded thereto.

Thermal expansion is particularly problematic where the coefficient of thermal expansion (CTE) of the battery case material differs substantially from that of the pin or insulative member material. For feedthrough constructions using a glass as the insulative member, it is generally desirable that the CTE of the battery case be greater than that of the glass, and that the CTE of the glass be greater than that of the pin. In these typical constructions, it is also important that the pin material be inert to the electrolyte, which is typically very corrosive. However, the protection afforded by the present invention allows for the use of multiple and varying pin 50 materials and construction. For example, the pin 50 may effectively be constructed of steels, such as stainless steels, and nickel alloys, such as KOVAR® alloy, and 42 alloy, that have CTEs compatible with a titanium case, even though they may not be suitable for direct contact with the electrolyte.

In order to couple the battery electrode to the feedthrough pin, a current collector 70 comprising a material selected to be compatible with the electrolyte is mechanically and electrically connected to the feedthrough pin 50 at an attachment point 67. Such compatible materials include aluminum, platinum, gold, niobium, tantalum, molybdenum, and stainless steel. Alternatively, the mechanical and electrical connections can be separated, using the principles taught in U.S. Pat. Nos. 6,063,523 and 6,458,171, each of which is assigned to the assignee of the present invention and incorporated herein by reference in its entirety. These two patents teach a method for connecting a tab to an electrode, but the principle of separating the electrical and mechanical connections can be applied to connecting a current collector to a feedthrough pin. Connection may be accomplished by a number of means including the use of a resistance weld 100 as is illustrated. Other connection methods include other forms of welding such as laser welding, and mechanical fasteners, such as crimps, clamps, rivets, screws, pressure fits, adhesives including conductive adhesives, and combinations thereof.

A protective covering 65 is provided to protect the pin 50 from exposure to the electrolyte, and may be in the form of a coating dispersed over at least a portion of both the pin 50 and current collector 70, covering at least the pin attachment point 67 and the portion of the pin that will lie within the interior of the battery case. The protective covering 65 comprises a material that can withstand exposure to electrolyte, and may comprise ceramic or a noble metal such as gold, with gold being a preferred material because of its high conductivity for improved rate capability.

As used herein, the term electrolyte refers to any solution or molten compound that conducts electricity. The electrolyte may be of various compositions, such as those formed from strong acids (HF, HCl, HBr, HI, HNO₃, H₂SO₄ and HClO₄), strong bases (all the Group IA and IIA hydroxides) and all soluble salts. Furthermore, the electrolyte may be formed by placing a liquid, such as a strong base, into a battery case containing battery components and allowing the liquid to physically or chemically react with the case and/or components to create the electrolyte for the battery. For a lithium ion battery, the electrolyte may comprise a nonaqueous, ionically conductive electrolyte comprising a salt, preferably an ionizable alkali metal salt, dissolved in a mixture of organic solvents chosen for their physical properties, such as viscosity, permittivity, and ability to dissolve the solute. Lithium salts known to be useful in lithium ion batteries include LiPF₆, LiBF₄, LiAsF₆, LiSbF₆, LiClO₄, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof. Solvents include esters, linear and cyclic ethers and dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy,2-methoxyethane (EME), ethyl methyl carbonate (EMC), methyl propyl carbonate, ethyl propyl carbonate, diethyl carbonate (DEC), dipropyl carbonate, cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone (GBL), N-methyl-pyrrolidinone (NMP), and mixtures thereof. A preferred electrolyte for a cell of the present invention comprises LiPF₆ in a mixture of cyclic and linear carbonates, preferably 30:70 EC:DEC.

The protective covering 65 protects the pin 50 from contact with electrolyte. The protective covering 65 may comprise a coating applied by plating such as electroplating, barrel plating, etc., chemical or physical vapor deposition, sputtering, ion implantation, or the like. The coating is preferably of a thickness less than 0.002 inches, and more preferably between 1 and 80 microns, while the most preferable thickness is approximately 5 microns. These thin coatings provide the needed barrier to the electrolyte without unduly diminishing the sealing ability between the pin and the insulative member 10. In the instance where gold is used for the coating, especially on stainless steel, a nickel strike, preferably between 10 and 300 angstroms can be done to improve the adhesiveness of the coating to the pin 50.

FIG. 2 is a diagram of a preferred embodiment of the present invention illustrating the current collector 70 of the feedthrough of FIG. 1 joined to an element 80, which comprises an electrode or a tab that is or will be joined to an electrode; element 80 is hereinafter referred to as electrode 80. The material of electrode 80 and that of current collector 70 are compatible with the electrolyte within battery case 10. Therefore, even though protective covering 65 may be penetrated during the connection of electrode 80 to current collector 70 at electrode attachment point 77, the materials that are exposed will not corrode upon exposure to the electrolyte. The connection of electrode 80 to current collector 70 may be made by any means known in the art and may comprise resistance welding, laser welding, and other forms of welding, or mechanical fasteners, such as crimps, clamps, rivets, screws, pressure fits, and adhesives, including conductive adhesives. When the coating is applied to form the protective covering 65, certain portions of the current collector 70 may be masked to prevent it from being deposited on those portions. When ceramic is used for the protective covering 65, it is especially useful to mask the portion of the current collector 70 that will be joined to electrode 80 at electrode attachment point 77 to keep ceramic from depositing on it. This obviates the need to actually break through a ceramic coating to make the electrical connection to the current collector.

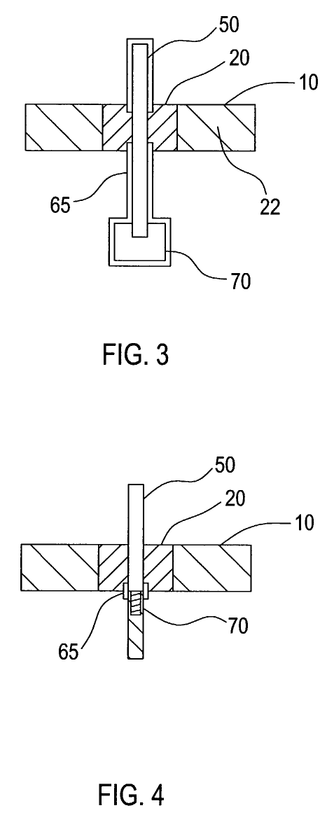

FIG. 3 is a diagram of another alternative preferred embodiment of the present invention illustrating its principal components. In this embodiment, the coating covers the bottom portion and optionally the top portion of the pin 50, leaving the center portion of the pin 50 uncoated. The coating extends onto the current collector 70 to at least completely cover the junction between pin 50 and current collector 70. Additionally, the coating 65 may partially or completely cover current collector 70. The insulative member 20 flows and conforms to the coated and uncoated portions of the pin, forming a seal. This embodiment is particularly useful when adhering the insulative member 20 directly to the material of pin 50 provides a better seal than the seal obtained with the material of protective covering 65. This may be the case either when forming a compression seal with a glass insulative member or when using a braze to seal a nonglass insulative member.

FIG. 4 is a diagram of an alternative embodiment of the present invention illustrating a design wherein pin 50 and current collector 70 essentially form a two-material pin. In this embodiment, the pin 50 and current collector 70 are joined by a screw (shown), a butt weld, a crimp, or the like. The end of pin 50 is aligned with the end of the insulative member 20 or may extend into the interior of the battery case such that the current collector 70 is positioned completely beneath the insulative member 20. A coating, forming protective covering 65, is dispersed at least over the portion of the pin 50 that would be exposed to electrolyte, ensuring that the junction between pin 50 and current collector 70 is covered; alternatively, the coating may be dispersed over the entire subassembly of pin 50 and current collector 70. By using the protective covering 65, alignment of the end of pin 50 with the end of the insulative member 20 is not critical. In a preferred material combination, when using a titanium case, KOVAR® alloy is utilized for the pin 50 and a corrosion resistant stainless steel is utilized for the current collector 70.

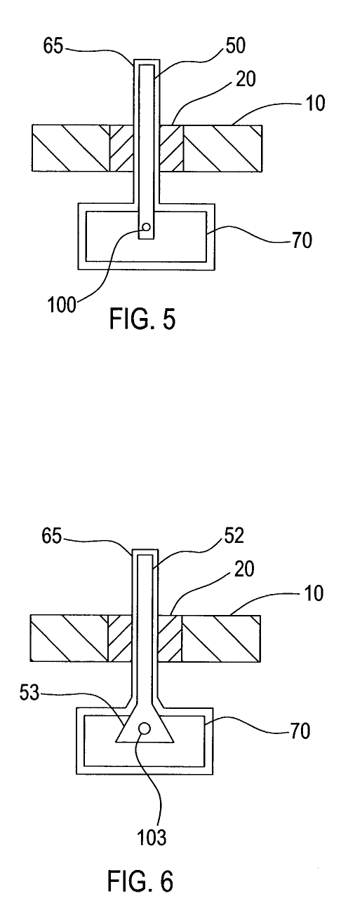

FIG. 5 is a diagram of yet another preferred embodiment of the present invention. Here, the pin 50 is connected to the current collector 70 by a resistance weld 100, as illustrated, or laser welding, mechanical fastener, crimp, clamps, rivets, screws, adhesives, or other method. The pin 50 and current collector 70 assembly receives a contiguous coating to form a protective covering 65 around the entire perimeter of the assembly. Alternatively, as in earlier-described embodiments, portions of the pin not exposed to the electrolyte and all except the pin attachment point 67 of the current collector may be left uncovered. The coated pin 50 extends through the insulative member 20 in battery case 10 as illustrated in previous embodiments.

FIG. 6 is a diagram of an alternative preferred embodiment of the present invention illustrating a custom pin 52 having a flattened base 53. The flattened base 53 of the custom pin 52 is designed to further support and strengthen the attachment between the pin 52 and the current collector 70. Here again, both the pin 52 and the current collector 70 have a contiguous coating forming protective covering 65. Also similar to the previous figure, the pin 50 can be connected to the current collector 70 by a mechanical fastener 103, as illustrated schematically, or welding, crimps, clamps, rivets, screws, pressure fits, adhesives, other methods, and combinations thereof. In both configurations illustrated in FIGS. 5 and 6, KOVAR® alloy may be used for the pin 50 material, and stainless steel, preferably SS446, may be used for the current collector 70 material.

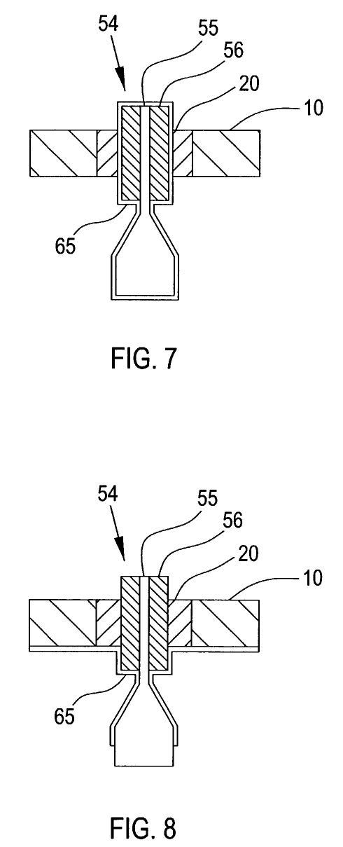

FIG. 7 is a diagram of an alternative embodiment of the present invention illustrating an alternative pin construction design. In this configuration, the current collector 70 extends to form a core 55 through a sheath 56, together forming a composite alternative pin 54. Because the thickness of the sheath 56 is large with respect to the core 55, the sheath 56 dictates the CTE of the composite pin. A coating is dispersed over the alternative pin 54 after assembly of the sheath 56 around the core 55 to form protective covering 65. Then the coated pin 54 is sealed within the insulative member 20. The battery case 10 and insulative member 20 are positioned similarly to previous embodiments. In this embodiment, SS316L is a preferred material for the core 55, gold is used for the protective covering 65, and KOVAR® alloy is used for the sheath 56.

FIG. 8 is a diagram of an alternative embodiment of the present invention similar to that shown in FIG. 7, in which the coating is applied after assembly of the pin 54 to the insulative member 20 to form protective covering 65. This order of steps can be applied to other embodiments described herein with similar results. When a conductive coating such as gold is used for protective covering 65, the coating must not be allowed to bridge the case and the pin, forming a short circuit. Therefore, the case and the outer edge of the insulative member 20 could be masked to ensure electrical isolation. On the other hand, and as illustrated in FIG. 8, if an insulative coating such as a nonconductive ceramic or plastic is used, this masking is not necessary. In fact, by allowing the insulative coating to extend onto the case 10, if good adhesion can be achieved between the insulative coating and the current collector 70, pin 50, and case 10, then even if poor or no adhesion is achieved to the glass, the electrolyte will still be unable to reach the pin 50. Furthermore, when using an insulative coating, the coating can be applied to the entire battery cover, thereby eliminating the need for a separate insulator component that is typically installed between the electrode assembly and the battery cover. When using a nonconductive protective covering 65, it may be desirable to mask the portion of current collector 70 that will be attached to the electrode to eliminate the need to penetrate the ceramic coating when connecting the current collector 70 to the electrode.

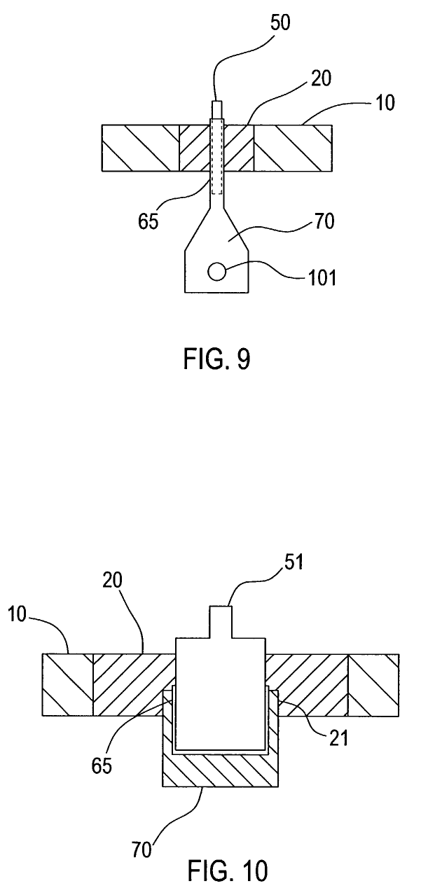

FIG. 9 is a diagram of an alternative embodiment of the present invention illustrating a current collector 70 that extends to cover pin 50 to form a protective covering 65 thereon. The material of current collector 70 is suitable for exposure to electrolyte, and the material of pin 50 has a CTE suitable for forming a seal with insulative member 20. The protective covering 65 is sufficiently thin so that its effect on the CTE of the overall pin structure (pin 50 plus protective covering 65) is small enough to allow a reliable seal with the insulative member 20. The maximum allowable thickness of protective covering 65 depends on the pin diameter, the materials, and the type of seal being formed. Ideally the thickness of the protective covering 65 does not exceed 0.020 inches (0.508 mm), and preferably is substantially thinner such as less than 0.002 inches, especially for smaller pin diameters. Preferable pin diameters are between 0.015-0.250 inches (0.381-6.350 mm), and most preferable pin diameters are between 0.015-0.120 inches (0.381-3.048 mm). As in all of the previous embodiments, the insulative member 20 may comprise a glass that forms a compression seal with the pin, or a nonglass ceramic that may be brazed to the pin. The protective covering 65 covers at least the bottom portion of pin 50 to prevent exposure of pin 50 to electrolyte. Ideally, KOVAR® alloy is utilized for pin 50 and stainless steel is utilized for the current collector 70. The current collector 70 may include a feature 101, such as a hole as shown, for mechanical fastening to an electrode.

FIG. 10 is a diagram of an alternative embodiment of the present invention illustrating its principal components, including a custom pin 51 illustrating a different shape that could be applied to other embodiments described herein, and a current collector 70 in the form of a cup. In this embodiment, prior to coupling the pin 51 with the current collector 70, a protective covering 65 is applied to protect at least the portion of the pin 51 that could otherwise be exposed to electrolyte. The protective covering 65 may comprise a braze that is used to couple pin 51 with current collector 70. As another alternative, the protective covering 65 may comprise a coating that is thick and robust enough to withstand a press fit of the coated pin into the current collector 70. As yet another alternative, the pin may be constructed of a material having a suitable CTE clad with a corrosion resistant material that forms the protective covering 65. Current collector 70 is then press fit, glued, brazed, or otherwise adhered to pin 51 in such a way as to form a seal between the protective covering 65 and the current collector 70 so that electrolyte cannot leak in to attack the corrosion prone material of pin 51. In this embodiment, the insulative member 20 may comprises a cutout 21 that allows for a portion of current collector 70 to nestle partially within the confines of insulative member 20. Although the wall of the cup formed by the current collector 70 may be so thick as to not allow matching of the pin/cup composite CTE and therefore not form a good seal with insulative member 20, a good seal is not required in this region, so long as a good seal is formed with the pin 51 in the region above the current collector 70 and the protective covering 65 keeps the electrolyte from contacting the pin 51.

The specific implementations disclosed above are by way of example and for enabling persons skilled in the art to implement the invention only. We have made every effort to describe all the embodiments we have foreseen. There may be embodiments that are unforeseeable and which are insubstantially different. We have further made every effort to describe the invention, including the best mode of practicing it. Any omission of any variation of the invention disclosed is not intended to dedicate such variation to the public, and all unforeseen, insubstantial variations are intended to be covered by the claims appended hereto. Accordingly, the invention is not to be limited except by the appended claims and legal equivalents.

What is claimed is:

1. A feedthrough assembly for an electrochemical cell comprising:
a case;
a pin extending through said case;
a current collector electrically coupled to said pin for connection to a positive electrode;
a protective covering physically separating said pin from the contents of the cell; and
an insulative member insulating said case from said pin; wherein
said pin comprises a pin material selected for its ability to form a seal with said insulative member; wherein
said current collector comprises a current collector material selected to be substantially unaffected by the contents of the cell; and wherein
said protective covering comprises a protective covering material selected to be substantially unaffected by the contents of the cell and chosen from the group consisting of: metal and ceramic.

2. A feedthrough assembly in claim 1 wherein at least a portion of said protective covering is sealed between said pin and said insulative member.

3. A feedthrough assembly in claim 1 wherein said case comprises titanium.

4. A feedthrough assembly in claim 3 wherein said insulative member is sealed directly to said case without a separate ferrule.

5. A feedthrough assembly in claim 4 wherein said pin material is selected to have a CTE compatible with said insulative member and with said case material.

6. A feedthrough assembly in claim 3 wherein said pin material is a nickel alloy.

7. A feedthrough assembly in claim 3 wherein said pin material comprises a nickel alloy chosen from the group consisting of: KOVAR® alloy and 42 alloy.

8. A feedthrough assembly in claim 1 wherein said pin has a diameter between 0.015 and 0.250 inches.

9. A feedthrough assembly in claim 1 wherein said pin has a diameter between 0.015 and 0.120 inches.

10. A feedthrough assembly in claim 1 wherein said current collector comprises a material chosen from the group consisting of: stainless steel, aluminum, platinum, gold, niobium, tantalum, and molybdenum.

11. A feedthrough assembly in claim 1 wherein said protective covering has a thickness of less than 0.002 inches.

12. A feedthrough assembly in claim 1 wherein said protective covering comprises a coating.

13. A feedthrough assembly in claim 1 wherein said protective covering comprises a coating of a thickness between 1 and 80 microns.

14. A feedthrough assembly in claim 1 wherein said protective covering comprises a braze between said pin and said current collector.

15. A feedthrough assembly in claim 1 wherein said protective covering comprises an extension of said current collector.

16. A feedthrough assembly in claim 1 wherein said protective covering comprises noble metal.

17. A feedthrough assembly in claim 1 wherein said protective covering comprises gold.

18. A feedthrough assembly in claim 1 wherein said protective covering comprises a coating comprising gold over a nickel strike.

19. A feedthrough assembly in claim 1 wherein said protective covering comprises stainless steel.

20. A feedthrough assembly in claim 1 wherein said protective covering is electrically insulative.

21. A feedthrough assembly in claim 1 wherein said protective coating comprises ceramic.

22. A feedthrough assembly in claim 1 wherein said insulative member comprises ceramic.

23. A feedthrough assembly in claim 22 wherein said insulative member comprises glass.

24. A feedthrough assembly in claim 1 wherein said current collector is coupled to said pin by a connector chosen from the group consisting of: a weld, a mechanical fastener, a crimp, a clamp, a rivet, a screw, a pressure fit, an adhesive, and combinations thereof.

25. A feedthrough assembly in claim 1 wherein said pin comprises a sheath and a core and wherein said current collector extends through said sheath to form said core.

26. A sealed battery comprising:
a feedthrough of claim 1;
a positive electrode coupled to said current collector;
a negative electrode housed within said case;
an electrolyte sealed within said case.

27. A battery in claim 26 wherein said electrolyte comprises a lithium salt dissolved in a solvent chosen from the group consisting of: esters, linear and cyclic ethers and dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy,2-methoxyethane (EME), ethyl methyl carbonate (EMC), methyl propyl carbonate, ethyl propyl carbonate, diethyl carbonate (DEC), dipropyl carbonate, cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone (GBL), N-methyl-pyrrolidinone (NMP), and mixtures thereof.

28. A battery in claim 26 wherein said electrolyte comprises a lithium salt dissolved in a mixture of cyclic and linear carbonates.

29. A battery in claim 26 wherein said electrolyte comprises LiPF₆ dissolved in EC:DEC.

30. A battery in claim 26 wherein said electrode is connected to said current collector by a connector chosen from the group consisting of: a weld, a mechanical fastener, a crimp, a clamp, a rivet, a screw, a pressure fit, an adhesive, and combinations thereof.

31. An electrochemical cell comprising:
a case comprising titanium;
a positive electrode housed within said case;
a negative electrode housed within said case;
an electrolyte activating said positive electrode and said negative electrode;
a pin extending through said case and having a diameter between 0.015 and 0.250 inches;
a current collector electrically coupled to said pin and to said positive electrode;
a protective covering physically separating said pin from said electrolyte; and
an insulative member sealed directly to said case and insulating said case from said pin wherein at least a portion of said protective covering is sealed between said pin and said insulative member; wherein
said pin comprises a pin material selected for its ability to form a seal with said insulative member; wherein
said current collector comprises a current collector material selected to be substantially unaffected by said electrolyte; and wherein
said protective covering comprises a protective covering material selected to be substantially unaffected by said electrolyte.

32. An electrochemical cell method in claim 31 wherein said protective covering comprises metal.

33. An electrochemical cell method in claim 31 wherein said protective covering comprises ceramic.

34. An electrochemical cell method in claim 31 wherein said protective covering comprises plastic.

35. A method for making a feedthrough assembly for connection to a positive electrode of an electrochemical cell, comprising:
providing a case;
providing a pin comprising a pin material selected for its ability to form a seal with said insulative member;
providing a current collector comprising a current collector material selected to be substantially unaffected by the contents of the cell;
electrically coupling said current collector to said pin;
at least partially covering said pin with a protective covering material selected to be substantially unaffected by the contents of the cell and chosen from the group consisting of: metal and ceramic;
positioning said pin within an insulative member;
positioning said insulative member within said case such that said pin extends through said case; wherein
said protective covering physically separates said pin from the contents of the cell.

36. A method in claim 35 comprising sealing at least a portion of said protective covering between said pin and said insulative member.

37. A method in claim 35 wherein said case comprises titanium.

38. A method in claim 37 wherein said insulative member is sealed directly to said case without a separate ferrule.

39. A method in claim 38 wherein said pin material is selected to have a CTE compatible with said insulative member and with said case material.

40. A method in claim 38 wherein said pin material is a nickel alloy.

41. A method in claim 38 wherein said pin material comprises a nickel alloy chosen from the group consisting of: KOVAR® alloy and 42 alloy.

42. A method in claim 35 wherein said pin has of a diameter between 0.015 and 0.250 inches.

43. A method in claim 35 wherein said pin has of a diameter between 0.015 and 0.120 inches.

44. A method in claim 35 wherein said current collector comprises a material chosen from the group consisting of: stainless steel, aluminum, platinum, gold, niobium, tantalum, and molybdenum.

45. A method in claim 35 wherein said protective covering has a thickness of less than 0.002 inches.

46. A method in claim 35 wherein said protective covering comprises a coating.

47. A method in claim 35 wherein said protective covering comprises a coating of a thickness between 1 and 80 microns.

48. A method in claim 35 wherein said protective covering comprises a braze.

49. A method in claim 35 wherein said protective covering comprises an extension of said current collector.

50. A method in claim 35 wherein said protective covering comprises noble metal.

51. A method in claim 35 wherein said protective covering comprises gold.

52. A method in claim 35 wherein said protective covering comprises a coating comprising gold over a nickel strike.

53. A method in claim 35 wherein said protective covering comprises stainless steel.

54. A method in claim 35 wherein said protective covering is electrically insulative.

55. A method in claim 35 wherein said protective coating comprises ceramic.

56. A method in claim 35 wherein said insulative member comprises ceramic.

57. A method in claim 56 wherein said insulative member comprises glass.

58. A method in claim 35 wherein said current collector is coupled to said pin by a connector chosen from the group consisting of: a weld, a mechanical fastener, a crimp, a clamp, a rivet, a screw, a pressure fit, an adhesive, and combinations thereof.

59. A method in claim 35 wherein said pin comprises a sheath and a core and wherein said current collector extends through said sheath to form said core.

60. A method for making a battery comprising:
making a feedthrough according to the method of claim 35;
coupling a positive electrode to the current collector;
housing a negative electrode within the case;
activating the positive electrode and the negative with an electrolyte.

61. A method in claim 60 wherein said electrolyte comprises a lithium salt dissolved in a solvent chosen from the group consisting of: esters, linear and cyclic ethers and dialkyl carbonates such as tetrahydrofuran (THF), methyl acetate (MA), diglyme, triglyme, tetraglyme, dimethyl carbonate (DMC), 1,2-dimethoxyethane (DME), 1,2-diethoxyethane (DEE), 1-ethoxy,2-methoxyethane (EME), ethyl methyl carbonate (EMC), methyl propyl carbonate, ethyl propyl carbonate, diethyl carbonate (DEC), dipropyl carbonate, cyclic carbonates, cyclic esters and cyclic amides such as propylene carbonate (PC), ethylene carbonate (EC), butylene carbonate, acetonitrile, dimethyl sulfoxide, dimethyl formamide, dimethyl acetamide, γ-valerolactone, γ-butyrolactone (GBL), N-methyl-pyrrolidinone (NMP), and mixtures thereof.

62. A method in claim 60 wherein said electrolyte comprises a lithium salt dissolved in a mixture of cyclic and linear carbonates.

63. A method in claim 60 wherein said electrolyte comprises LiPF₆ dissolved in EC:DEC.

64. The method of claim 60 wherein said act of coupling a positive electrode to the current collector comprises:
connecting an electrode to said current collector by a connector chosen from the group consisting of: weld, mechanically fastener, crimp, clamp, rivet, screw, pressure fitting, or adhesive bond.
